(19) United States
(12) Patent Application Publication
(10) Pub. No.: US 2019/0347954 A1
(43) Pub. Date: Nov. 14, 2019

(54) System and Method of Selective Interaction with Online Educational Programs

(71) Applicants: Mathios Belachew Asfaw, Shanghai (CN); Murray Keith Owen, Shanghai (CN)

(72) Inventors: Mathios Belachew Asfaw, Shanghai (CN); Murray Keith Owen, Shanghai (CN)

(21) Appl. No.: 16/409,774

(22) Filed: May 10, 2019

Related U.S. Application Data
(60) Provisional application No. 62/669,515, filed on May 10, 2018.

(51) Int. Cl. G09B 19/00; G06T 7/246; G06T 7/00; H04L 29/08; H04L 12/18

(52) U.S. Cl. CPC G09B 19/00; G06T 7/248; G06T 7/0002; G06T 2207/30196; H04L 12/1813; G06T 2207/10016; H04L 67/16

(57) ABSTRACT

A system and method of interaction with online educational programs provides a user with the ability to teach or enroll in classes remotely. The system accomplishes this by collecting user educational history information, professional history information, and user requests and connecting users via several remote servers. The system includes a plurality of user accounts managed by at least one remote server. The plurality of user accounts relates to a collection of data and information related to each user of the present invention. The at least one remote server is a computing device remotely accessible by the plurality of user accounts that allows for capture, organization, and transmission of data from the plurality of user accounts. Each user account is associated with a corresponding personal computing (PC) device. This arrangement enables each user to interact with the at least one remote server using the corresponding PC device.

The current application claims a priority to the U.S. Provisional Patent application Ser. No. 62/669,515 filed on May 10, 2018.

The current application also claims a priority to the Chinese patent application serial number 201910125744.9 filed on Feb. 19, 2019.

### FIELD OF THE INVENTION

The present invention generally relates to a learning system. More specifically, a system and method of selective interaction with online educational programs promotes the flexibility of teaching methods, a variety of subjects, and social interactions between every user registered with the system, regardless the role played by the user. Artificial intelligence converts user work experience, taken classes, and similar criteria into a projected path of suggested courses to help the user achieve a personal or professional goal.

### BACKGROUND OF THE INVENTION

As technology reduces the barriers between people, the amount of new information in a modern human life has grown exponentially. As a result, professional skills and information taught in facilities of higher education often become obsolete within a few years. It is therefore very important for a working professional to continuously update professional skills, knowledge, and resources.

Unfortunately, several issues arise for people trying to stay current, especially outside of a formal learning environment. While studying at a university is a full-time job for many undergraduate and graduate students, studying while employed is generally not as important as maintaining a professional position. Beyond this, many practical skills are never even taught in a formal educational setting. It is difficult to match a willing and qualified teacher with students who are willing to learn. Furthermore, often a student who enrolls in a class or learning path will become stuck or disinterested in the course material, which may lead to that student dropping out of the course. What is needed is a program that keeps students engaged in their education, with educators who are not only qualified and prepared but also compensated fairly for their efforts. Further desirable is a service that provides suggested classes to the student in order to help that student reach an educational or professional goal.

The present invention addresses these issues. The present invention can be accessed through a variety of personal computing (PC) devices, allowing a user to select and study class material at the user's discretion. The present invention allows educators to teach their own way, allowing flexibility that can enhance the student experience. Augmented reality, virtual reality technology, and real-time communication is available, allowing teachers to convey knowledge to students in different forms, thus increasing student engagement with course material. For example, a course about Chinese language or culture may be enhanced by allowing a student to follow a teacher as the teacher walks down a street in Beijing, demonstrating common interactions in Chinese culture. The present invention does not strictly define a user as either a student or a teacher; every educator in one field can choose to be a student in a different or related field. This greatly expands the potential pool of teachers. Moreover, if a user cannot find a class, the user can submit a request and course description as a means of recruiting potential teachers, who can then decide whether they are willing to create the course syllabus and content. If there are no qualified candidates, the present invention may advertise the need in order to attract other potential teachers. Finally, the interactive learning system also provides a flexible way of paying the teacher, as the system allows the student to pay course tuition independently or with pooled money from several other students, allowing students to pay their tuition together.

### SUMMARY OF THE INVENTION

The present invention provides an interactive learning system to promote flexibility of teaching and learning. With this system, a registered user can be a student, a teacher, or both. As a teacher, the user can set up the courses according to his or her own expertise, choose the method of teaching, and present the material to students in different ways. As a student, the user can choose a course at his or her own discretion, request a class when necessary, and can pay the teacher alone or in a group.

### BRIEF DESCRIPTION OF THE DRAWINGS

FIG. 1 is a flowchart illustrating the system of the present invention.

FIG. 2A is a flowchart illustrating the overall process for the method of the present invention.

FIG. 2B is a continuation of FIG. 2A.

FIG. 3 is a flowchart illustrating the subprocess of matching user accounts as students to classes online.

FIG. 4 is a flowchart illustrating the subprocess of matching experientially similar users.

FIG. 5 is a flowchart illustrating the subprocess of applying more weight to professional experiences when determining account similarity.

FIG. 6 is a flowchart illustrating the subprocess of applying more weight to professional certifications when determining account similarity.

FIG. 7 is a flowchart illustrating the subprocess of connecting the specific user to the similar user.

FIG. 8 is a flowchart illustrating the subprocess of scheduling a tutoring session.

FIG. 9 is a flowchart illustrating the subprocess of matching user accounts as teachers to online classes.

FIG. 10 is a flowchart illustrating the subprocess of implementing an online class in a real-time communication format.

FIG. 11 is a flowchart illustrating the subprocess of implementing an online class in a virtual-reality format.

FIG. 12 is a flowchart illustrating the subprocess of implementing an online class in a motion-training or motion-intensive format.

FIG. 13 is a flowchart illustrating the subprocess of implementing a live training session between a student and a teacher in conjunction with the online class in the motion-training or motion-intensive format.

FIG. 14 is a flowchart illustrating the subprocess of searching for specific online classes.

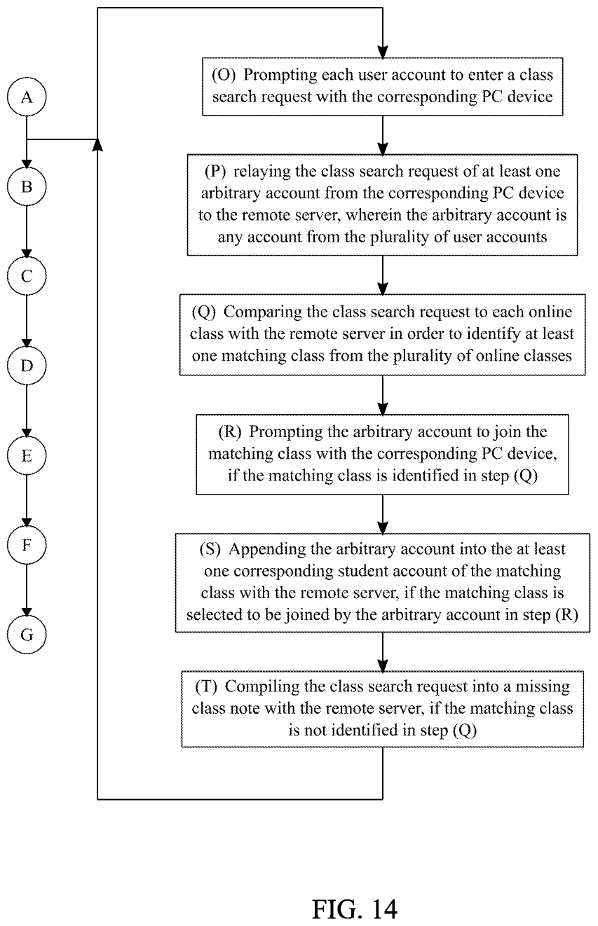

FIG. 15A is a flowchart illustrating the subprocess of creating a new class in order to satisfy the needs of the users.

FIG. 15B is a continuation of FIG. 15A.

### DETAILED DESCRIPTION OF THE INVENTION

All illustrations of the drawings are for the purpose of describing selected versions of the present invention and are not intended to limit the scope of the present invention.

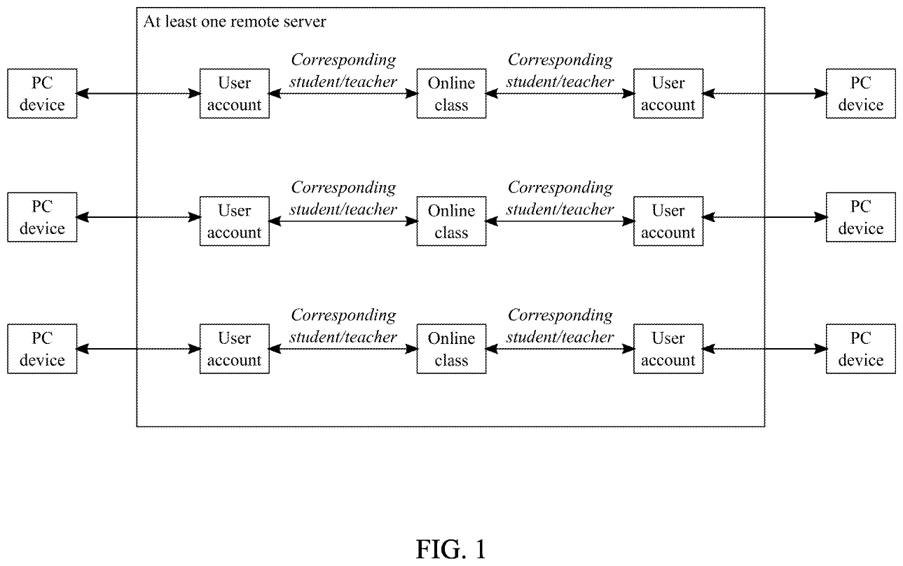

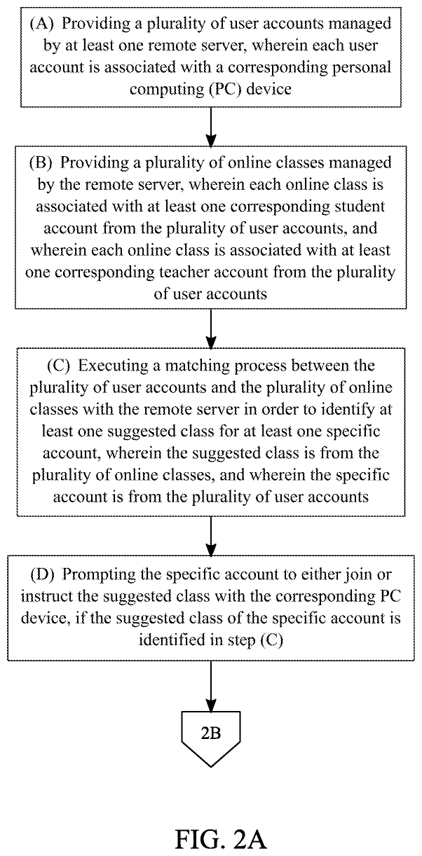

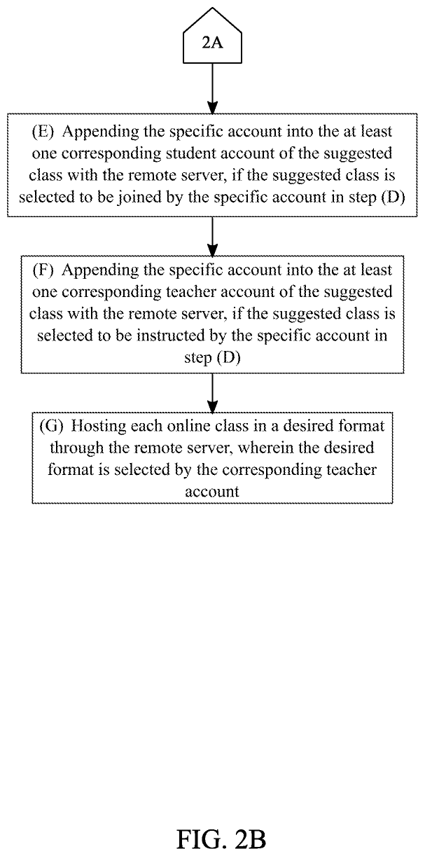

The present invention is a system and method of interaction with online educational programs that provides a user with the ability to teach or enroll in classes remotely. The present invention accomplishes this by collecting user educational history information, professional history information, and user requests and connecting users via several remote servers. The system of the present invention includes a plurality of user accounts managed by at least one remote server (Step A), as shown in FIG. 1. The plurality of user accounts relates to a collection of data and information related to each user of the present invention. The at least one remote server is a computing device remotely accessible by the plurality of user accounts that allows for capture, organization, and transmission of data from users of the present invention. Each user account is associated with a corresponding personal computing (PC) device, as represented in FIGS. 2A and 2B. The corresponding PC device is any of a variety of computing machines, which includes, but is not limited to, desktop computers, mobile devices, smartphones, and more, capable of connecting to the at least one remote server. This arrangement enables each user to interact with the at least one remote server using the corresponding PC device.

The present invention follows an overall process in order to connect users to classes. For the overall process, the method of the present invention includes a plurality of online classes managed by the remote server (Step B) as shown in FIGS. 2A and 2B. The plurality of online classes relates to the set of courses available to users, including all course materials. Each online class is associated with at least one corresponding student account from the plurality of user accounts. The at least one corresponding student account is a user account that interacts with an online class as a student. Moreover, each online class is associated with at least one corresponding teacher account from the plurality of user accounts. The at least one corresponding teacher account is a user account that interact with an online class as the teacher. Thus, each online class is attended by at least one user that is a student and at least one user that is a teacher. The overall process continues by executing a matching process between the plurality of user accounts and the plurality of online classes with the remote server in order to identify at least one suggested class for at least one specific account (Step C). By executing the matching process, similarities and differences between different user accounts can be determined and subsequently utilized for analysis by artificial intelligence to determine the suggested class. The suggested class is from the plurality of online classes. Furthermore, the specific account is from the plurality of user accounts. Step C ensures that the suggested class is equipped with at least one teacher some students and that the specific account is connected to an appropriate class that may suit the interests of the user.

The specific account is then prompted to either join or instruct the suggested class with the corresponding PC device, if the suggested class of the specific account is identified in Step C (Step D). Thus, the specific account is able to follow the determined suggestions, which will ultimately provide the specific account with the necessary educational opportunities to achieve a goal or professional certification. The specific account is appended into the at least one corresponding student account of the suggested class with the remote server, if the suggested class is selected to be joined by the specific account in Step D (Step E). In this way, the user of the specific account is able to enroll in the suggested online class as a student. Alternatively, the specific account is appended into the at least one corresponding teacher account of the suggested class with the remote server, if the suggested class is selected to be instructed by the specific account in Step D (Step F) as represented in FIG. 2B. Thus, user the specific account is able to manage and instruct the suggested online class as a teacher. Finally, each online class is hosted in a desired format through the remote server, wherein the desired format is selected by the corresponding teacher account (Step G). The desired format may include a variety of different media types and improving modern technologies.

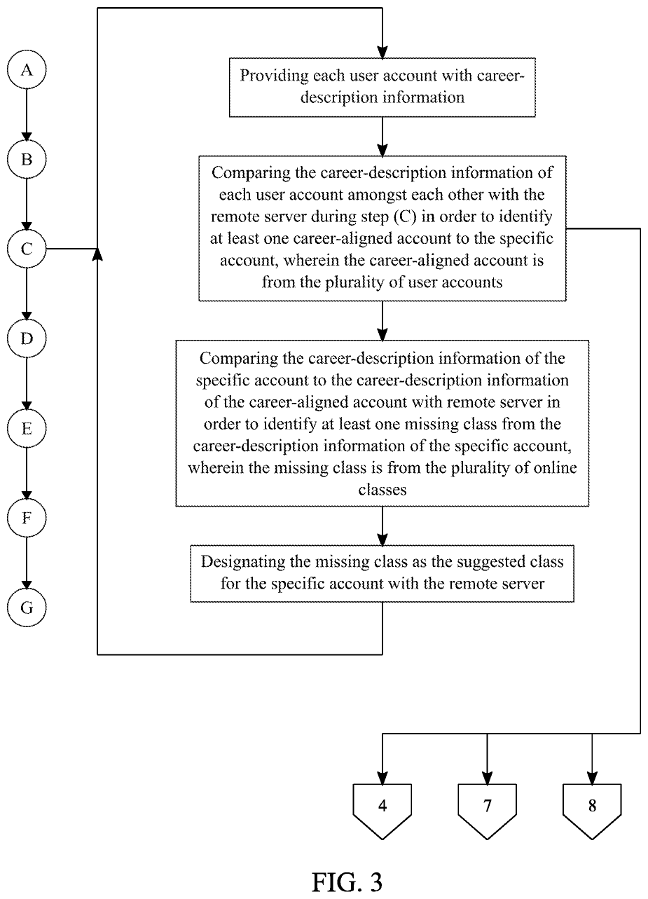

To determine the best possible class recommendations, the present invention collects data and general information about each of the plurality of user accounts. To this end, each user account includes career-description information. The career description information may include, but is not limited to, social media accounts, academic background, work experience, certifications, hobbies, volunteer experiences, publicly available records, and more user information. Such information is extremely helpful for training a deep learning artificial intelligence. The career-description information of each user account is compared amongst each other with the remote server during Step C in order to identify at least one career-aligned account to the specific account, as represented in FIG. 3. In this way, the specific account is found to be similar to one or more other user accounts in terms of educational and/or career path. The career-description information of the specific account is then compared to the career-description information of the career-aligned account with remote server in order to identify at least one missing class from the career-description information of the specific account, wherein the missing class is from the plurality of online classes. The missing class is an online class that, if taken by a student, would complete a learning path towards a professional or personal goal. Next, the missing class is designated as the suggested class for the specific account with the remote server. In this way, the missing class is presented to the specific account in Step E so the specific account can choose to enroll in the missing class.

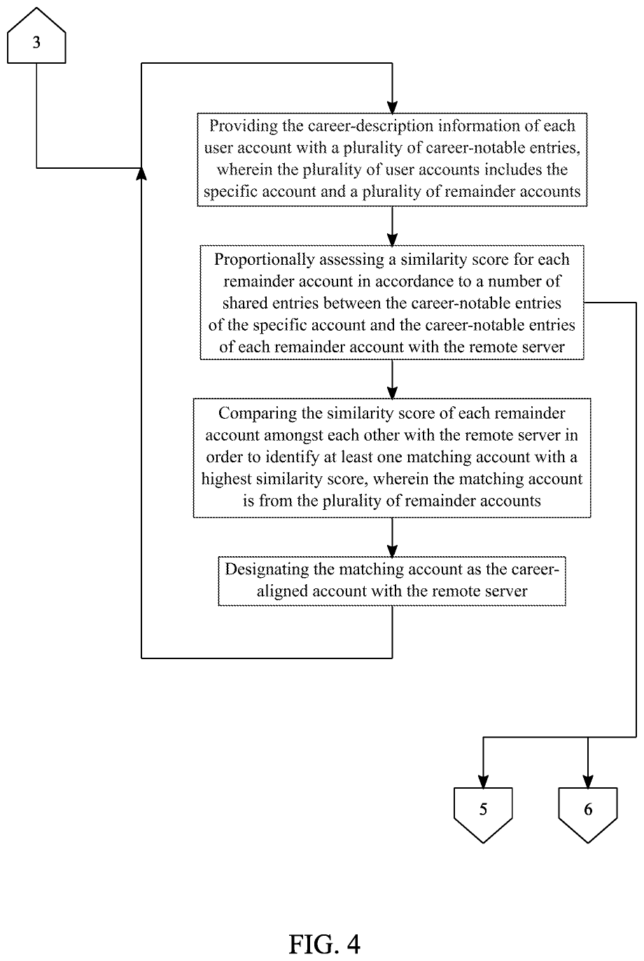

Among the important criteria for determining career paths and similar user accounts is understanding the career history of the user. To this end, the career-description information of each user account is provided with a plurality of career-notable entries. The plurality of career-notable entries is a resume for each user account that provides a useful data point for artificial intelligence training. The plurality of user accounts includes the specific account and a plurality of remainder accounts. In this way, the specific account is able to be analyzed and compared to all of the other existing accounts. The similarity score for each remainder account is proportionally assessed in accordance to a number of shared entries between the career-notable entries of the specific account and the career-notable entries of each remainder account with the remote server, as shown in FIG. 4. The similarity score can be used to quantify the similarities between different user accounts. Next, the similarity score of each remainder account is compared amongst each other with the remote server in order to identify at least one matching account with a highest similarity score, wherein the matching account is from the plurality of remainder accounts. In this way, differences and similarities between user accounts are known and recorded by the remote server. Finally, the matching account is designated as the career-aligned account with the remote server. Thus, the remote server is equipped to provide the specific account with at least one career-aligned account, which may be subsequently presented to the specific account in the form of a friend request suggestion.

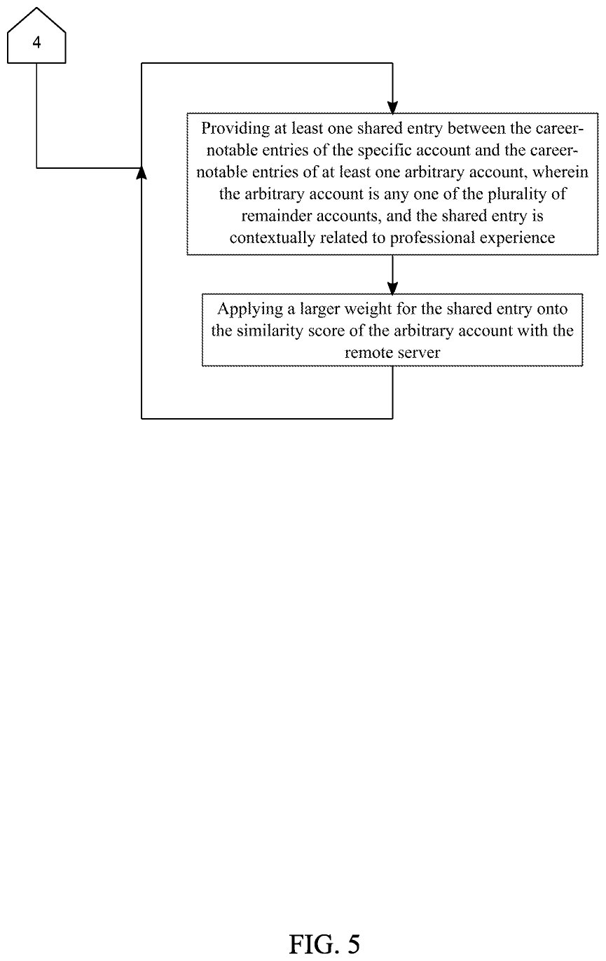

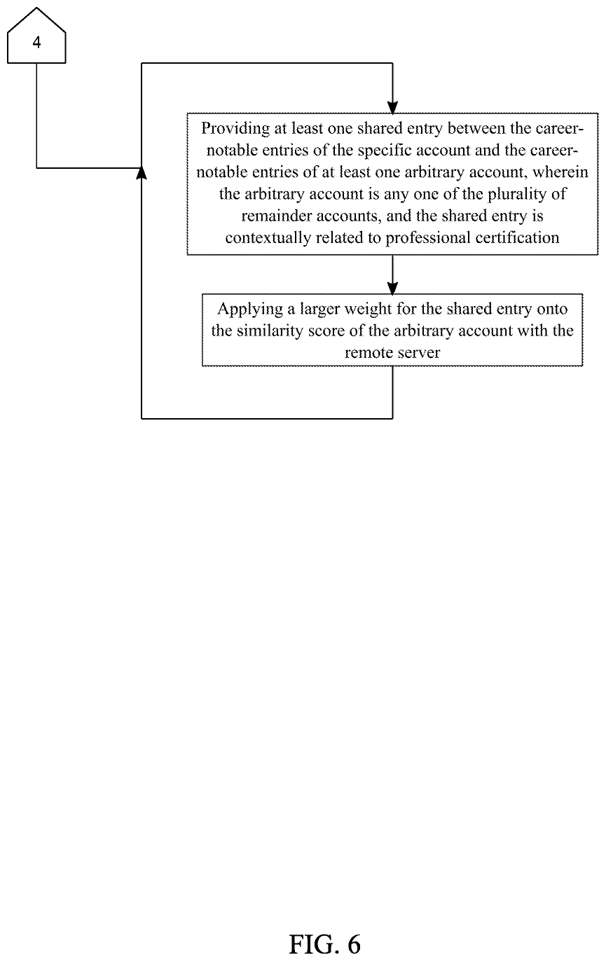

When determining the similarity score, it may be advantageous to weigh certain pieces of personal information with a different scale than other pieces of personal information. To this end, at least one shared entry between the career-notable entries of the specific account and the career-notable entries of at least one arbitrary account is provided, wherein the arbitrary account is any one of the plurality of remainder accounts, and the shared entry may be contextually related to professional experience, as represented in FIG. 5. Professional experience may include, but is not limited to, work experience, educational experiences, internships, apprenticeships, and other such undertakings. Such professional experience is valuable as lessons gained from experience are taught thoroughly enough for real-world application. A larger weight for the shared entry is applied onto the similarity score of the arbitrary account with the remote server. Thus, work experience is weighed more heavily in determining similarity scores than other criteria, such as user hobbies and interests. Alternatively, the shared entry may be contextually related to professional certification, as represented in FIG. 6. Professional certification may include, but is not limited to, work certificates, course badges from completing courses of the present invention, awards, or other such recognition of professional achievement. A larger weight for the shared entry is applied onto the similarity score of the arbitrary account with the remote server. Thus, professional certification is weighed more heavily in determining similarity scores than other criteria, such as user hobbies and interests.

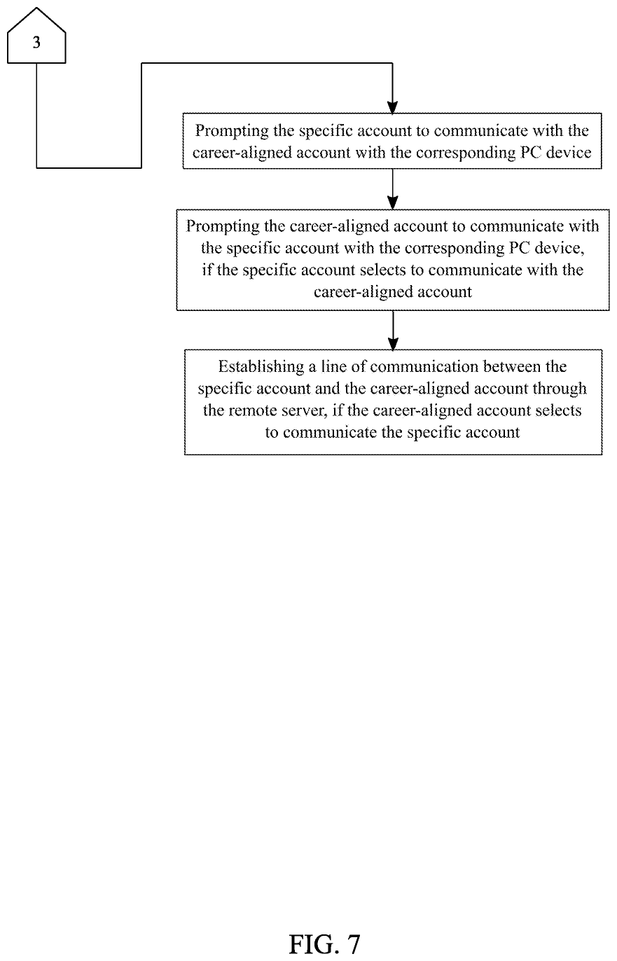

Among the most effective mechanisms for increasing retention of information is by connecting people who are attempting to learn similar information. In order to provide a more friendly learning environment and increase course retention, the specific account is prompted to communicate with the career-aligned account with the corresponding PC device, as shown in FIG. 7. Such interaction enables the specific account to approve of establishing a line of communication with the career-aligned account. Subsequently, the career-aligned account is prompted to communicate with the specific account with the corresponding PC device, if the specific account selects to communicate with the career-aligned account. The career-aligned account is consequently able to approve of opening a line of communication with the specific account. Finally, a line of communication is established between the specific account and the career-aligned account through the remote server, if the career-aligned account selects to communication the specific account. Upon completion, the specific account is able to communicate with the career-aligned account, enabling coordination and discussion about course materials, as well as providing further data for determining suggested classes and/or providing career advice.

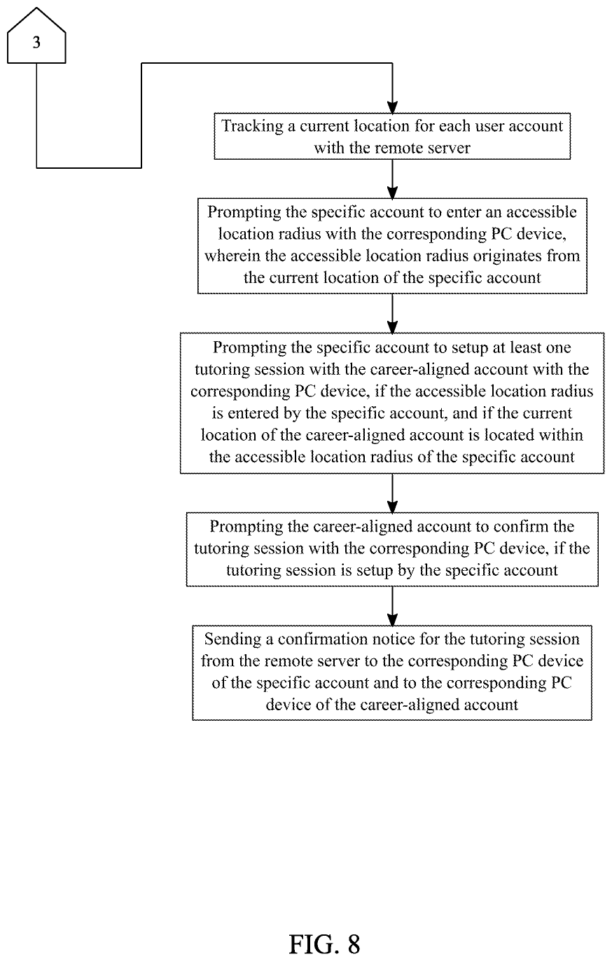

Many students learn best from in-person meeting with other students following the same educational and/or professional path. In order to accommodate this desire, a current location for each user account is tracked with the remote server. This enables the remote server to determine a concentration or absence of user accounts in a given geospatial area. The specific account is prompted to enter an accessible location radius with the corresponding PC device, wherein the accessible location radius originates from the current location of the specific account. Thus, the user of the specific account provides information related to their physical mobility, allowing the remote server to determine a reasonable geospatial range. Next, the specific account is prompted to setup at least one tutoring session with the career-aligned account with the corresponding PC device, if the accessible location radius is entered by the specific account, and if the current location of the career-aligned account is located within the accessible location radius of the specific account, as shown in FIG. 8. Accordingly, the specific account is able to request a physical meeting with another student when this other student is near to the specific account. The career-aligned account is prompted to confirm the tutoring session with the corresponding PC device, if the tutoring session is setup by the specific account. In this way, the user of the career-aligned account is able to accept or reject a meeting with a student. Then, a confirmation notice for the tutoring session is sent from the remote server to the corresponding PC device of the specific account and to the corresponding PC device of the career-aligned account. Thus, both the specific account and the career-aligned account are aware of the scheduled meeting.

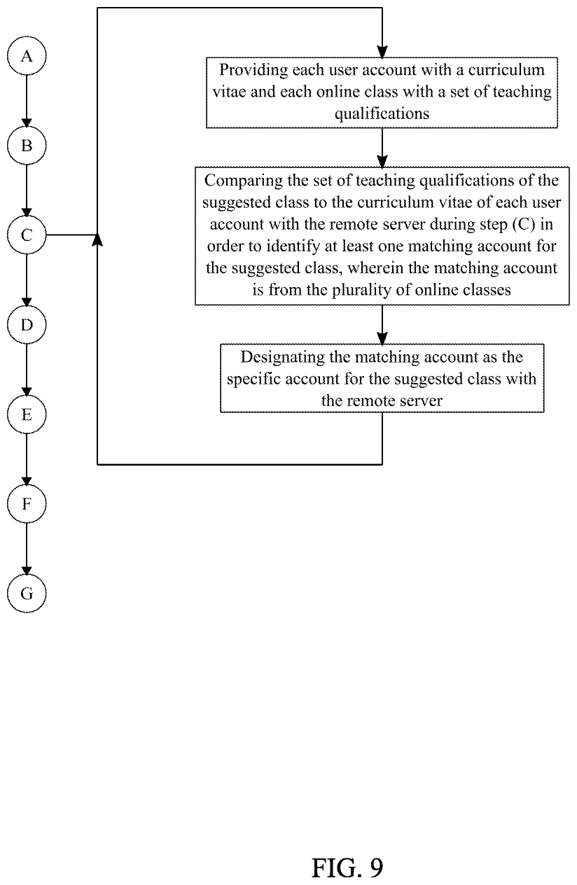

An important factor in determining course success is ensuring high quality educators for each online class by filtering potential candidates. To achieve this, each user account is provided with a curriculum vitae and each online class with a set of teaching qualifications, as represented in FIG. 9. This information may include teaching history as well as relevant coursework and general work experience. The set of teaching qualifications of the suggested class is compared to the curriculum vitae of each user account with the remote server during Step C in order to identify at least one matching account for the suggested class, wherein the matching account is from the plurality of online classes. The matching account may then be determined to be eligible for a teaching role in the given class. The matching account is designated as the specific account for the suggested class with the remote server. Thus, a teacher is determined to be qualified to teach a given class based upon the teacher's educational and work history.

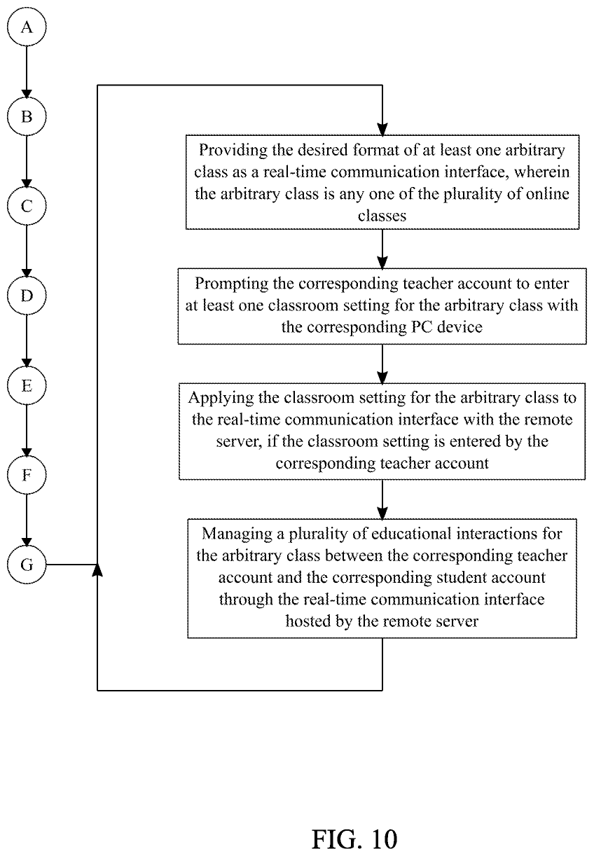

Pre-recorded educational content alone is rarely effective as a teaching method, as such information leaves the user isolated during the learning process. To generate a more engaging atmosphere, the desired format of at least one arbitrary class is provided as a real-time communication interface, wherein the arbitrary class is any one of the plurality of online classes, as represented in FIG. 10. Real-time communication interfacing results in increased user engagement in course material, ensuring that the learner can receive direct help from a teacher. The corresponding teacher account is prompted to enter at least one classroom setting for the arbitrary class with the corresponding PC device. The classroom setting can improve the student's ability to focus during lessons, particularly when the setting moves away from a conventional classroom. The classroom setting for the arbitrary class is subsequently applied to the real-time communication interface with the remote server, if the classroom setting is entered by the corresponding teacher account. The teacher account may deem certain course material to be better absorbed by changing the learning environment. A plurality of educational interactions for the arbitrary class is managed between the corresponding teacher account and the corresponding student account through the real-time communication interface hosted by the remote server. These educational interactions may include sharing of files, PC device screens, visual aids, audio aids, whiteboard work, as well as text chat, live collaboration, team groupings, live polling, exams, or a variety of other interactive media.

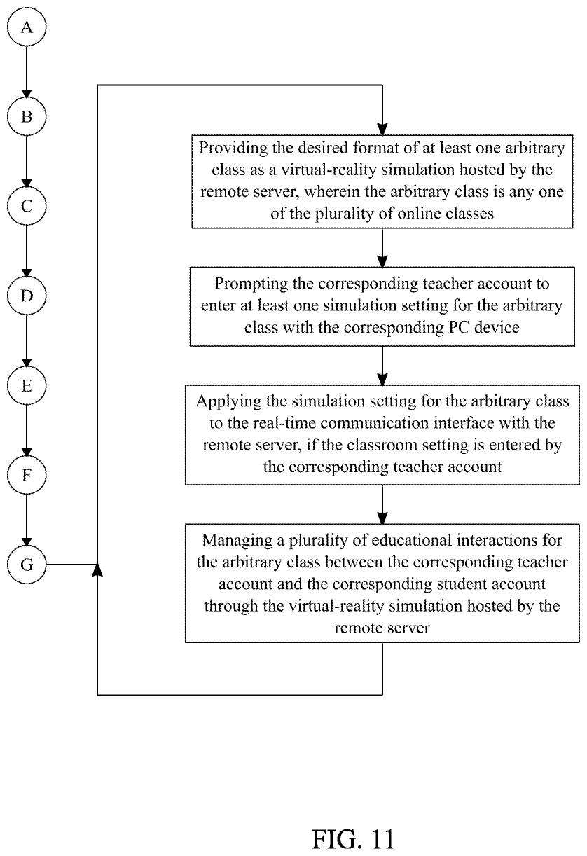

As technology advances, so too do potential learning avenues for interested and prepared students. The desired format of at least one arbitrary class may therefore be provided as a virtual-reality simulation hosted by the remote server, wherein the arbitrary class is any one of the plurality of online classes. Virtual-reality technology allows a student to share a simulated space with a teacher, enabling the student to actively sit in a classroom with a teacher for an immersive educational experience. The corresponding teacher account is prompted to enter at least one simulation setting for the arbitrary class with the corresponding PC device, as shown in FIG. 11. This allows the teacher to perform a virtual tour of a relevant location or setting to enhance raw teaching material. The simulation setting for the arbitrary class is applied to the real-time communication interface with the remote server, if the classroom setting is entered by the corresponding teacher account. Thus, students are invited to participate in virtual-reality classes. A plurality of educational interactions for the arbitrary class are managed between the corresponding teacher account and the corresponding student account through the virtual-reality simulation hosted by the remote server. This arrangement ensures that all coursework and information is documented and ready for review by the corresponding student account or the corresponding teacher account.

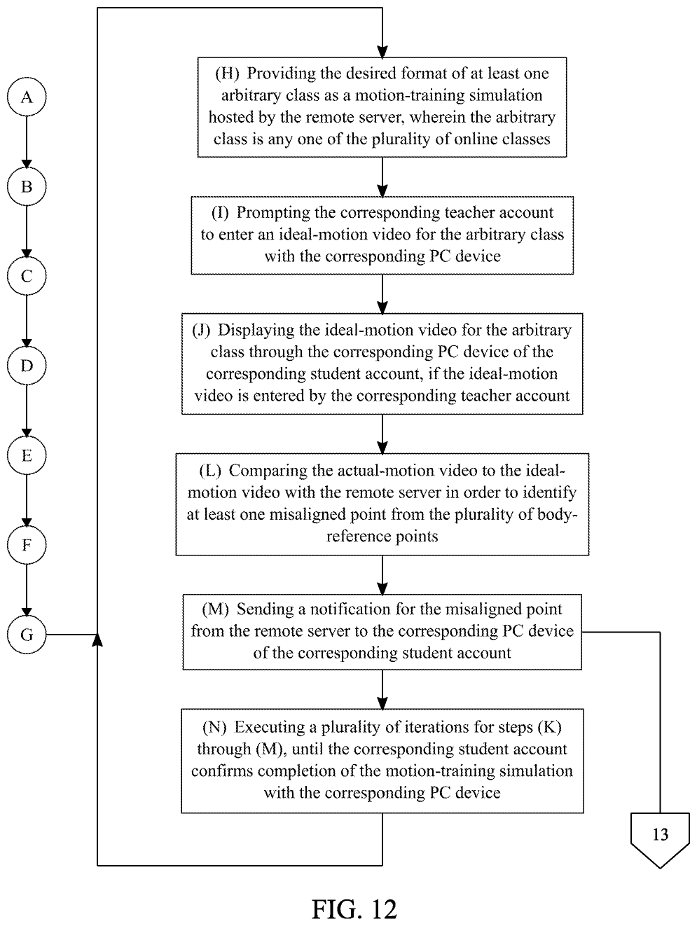

Improvements in technology now allow for the usage of precise motion-detection software with many cameras, which the present invention enables. The desired format of at least one arbitrary class is provided as a motion-training simulation hosted by the remote server, wherein the arbitrary class is any one of the plurality of online classes, as shown in Step H and represented in FIG. 12. A motion-training simulation is particularly advantageous in enabling active classes, such as painting, guitar lessons, workouts, or more. The corresponding teacher account is prompted to enter an ideal-motion video for the arbitrary class with the corresponding PC device, as shown in Step I. In this way, the teacher is able to demonstrate proper form for a given exercise. The ideal-motion video for the arbitrary class is displayed through the corresponding PC device of the corresponding student account, if the ideal-motion video is entered by the corresponding teacher account, as shown in Step J. Thus, the student is provided with an example of correct motion to replicate. A plurality of body-reference points is captured during an actual-motion video with the corresponding PC device of the corresponding student account, as shown in Step K. This arrangement enables the corresponding PC device to determine the student's motions for subsequent analysis. The actual-motion video is compared to the ideal-motion video with the remote server in order to identify at least one misaligned point from the plurality of body-reference points, as shown in Step L. Such a demonstration displays the errors in the precise motion required to perform a task, using the instructor's demonstrated understanding of correctness as a reference. A notification for the misaligned point is sent from the remote server to the corresponding PC device of the corresponding student account, as shown in Step M. This arrangement provides the student with a mechanism for detecting specific errors in execution. A plurality of iterations for Steps K through M, until the corresponding student account confirms completion of the motion-training simulation with the corresponding PC device, as shown in Step N. In this way, the student is able to refine the performed motion until it adequately matches the desired motion.

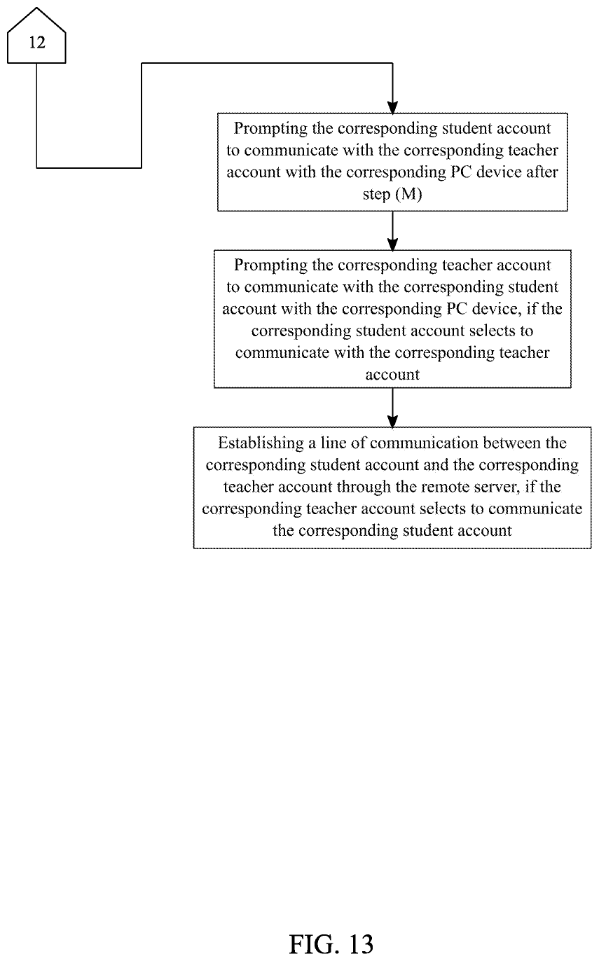

While practice presumably makes perfect, a frustrated student may become discouraged at several failed attempts and may need to speak to the teacher. To provide this opportunity, the corresponding student account is prompted to communicate with the corresponding teacher account with the corresponding PC device after Step M. The prompt may appear after a certain number of failed attempts, as determined by the corresponding teacher account and the remote server. The corresponding teacher account is then prompted to communicate with the corresponding student account with the corresponding PC device, if the corresponding student account selects to communicate with the corresponding teacher account, as represented in FIG. 13. Thus, the corresponding teacher account may determine whether it is appropriate to step in for further student instruction. Finally, a line of communication is established between the corresponding student account and the corresponding teacher account through the remote server, if the corresponding teacher account selects to communicate the corresponding student account. Such an arrangement results in the corresponding teacher account being available for interaction with the corresponding student account.

The remote server must be equipped to identify desired classes and relay those classes on to the relevant user account as needed. To provide each user account with the right classes upon request, each user account is prompted to enter a class search request with the corresponding PC device (Step O) as shown in FIG. 9. The prompt is the user's mechanism for interacting with all of the classes stored upon the remote server. The class search request of at least one arbitrary account is then relayed from the corresponding PC device to the remote server, wherein the arbitrary account is any account from the plurality of user accounts (Step P). The remote server is then equipped with the information needed to handle the class search request. The class search request is compared to each online class with the remote server in order to identify at least one matching class from the plurality of online classes (Step Q). This verification step verifies that the class description and title adequately matches at least one existing class available to the remote server. The arbitrary account is next prompted to join the matching class with the corresponding PC device, if the matching class is identified in Step Q (Step R). In this way, an existing class may be determined to be available for the arbitrary account. The arbitrary account is appended into the at least one corresponding student account of the matching class with the remote server, if the matching class is selected to be joined by the arbitrary account in Step R (Step S). This completes the connection of the student to a desired class, if the class is found to be available in Step Q. The class search request is compiled into a missing class note with the remote server, if the matching class is not identified in Step Q (Step T). This missing class note determines the absence of the requested class from the remote server.

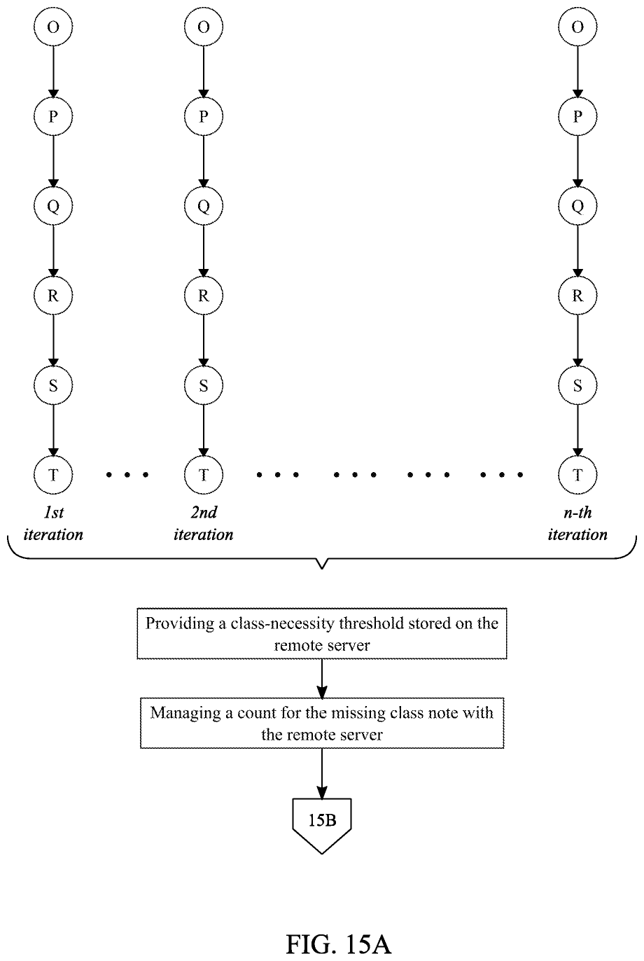

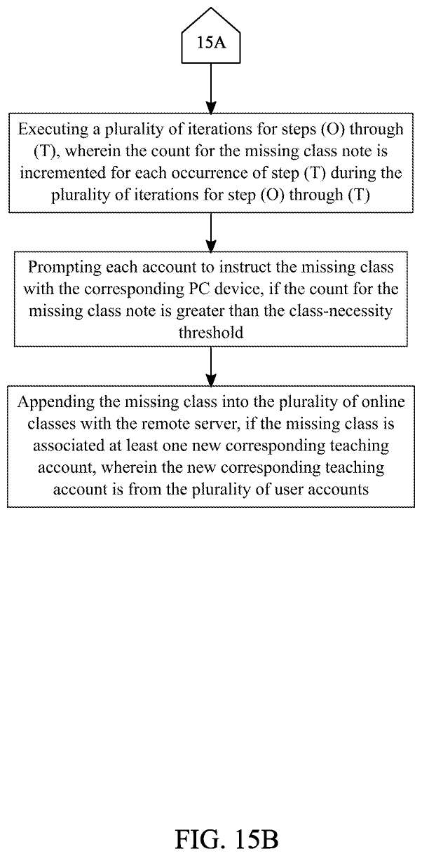

There may be classes or topics that a student would like to take which are not available when the student is able to enroll. In order to provide classes as needed and when desired, a class-necessity threshold is stored on the remote server. The class-necessity threshold is an integer representing the minimum number of interested people in a particular class. A count for the missing class note is managed with the remote server. This count is an integer to be compared to the class-necessity threshold. A plurality of iterations for Steps O through T is executed, as represented in FIGS. 15A and 15B, wherein the count for the missing class note is incremented for each occurrence of Step T during the plurality of iterations for Steps O through T. Thus, the count accurately reflects user interest in a particular class or course of study. Each user account is prompted to instruct the missing class with the corresponding PC device, if the count for the missing class note is greater than the class-necessity threshold. In this way, demand can result in course creation by any of the user accounts. A user may further provide information including scheduling preferences, course pricing desired, class size, and other such variables. The missing class is then appended into the plurality of online classes with the remote server, if the missing class is associated with at least one new corresponding teaching account, wherein the new corresponding teaching account is from the plurality of user accounts. Upon completion, the course is thus made available to all user accounts.

### Supplemental Description

The present invention presents an interactive learning system that can solve all the issues above. First of all, it is a system that can be installed onto a portable or home electronic device and allow the user to select and take the class at the user's discretion. Second, this system does not strictly define the user to be a student or a teacher. Every registered user can choose to be either or both. Since everyone has his or her own expertise, one person can be a teacher in one area, and be a student in the other area. This greatly expands the potential pool of teachers. Moreover, if a user cannot find a class, the user can put a request on the system for other potential teachers to decide whether they are willing to create a course and teach this subject. If no teacher can teach this course, then the system can also advertise the need and attract other potential teachers. Third, this system presents a very flexible teaching method, which allows teachers to use their own way to teach different subjects. With the augmented reality and virtual reality technology, teachers have many ways to convey various knowledge in different forms to students. For example, if students took a course to learn Chinese, a teacher may walk on a street in China or Taiwan and present to students how to interact in Chinese in a daily life. Finally, the interactive learning system also provides a flexible way of paying the teacher, because the system allows the student to pay the tuition alone or can pool the money together with several other students to pay the tuition together.

The present invention is an interactive learning system that can be installed on user's portable or other electronic devices. This system is configured to provide flexibility to both teacher and student by allowing the teacher to choose what to teach and allowing the student to choose what to learn. Every registered user may choose to be a student in one area or be a teacher in another area. The system comprises a plurality of major systems. Each of the plurality of major systems further comprises a plurality of subsystems. In the present embodiment, the plurality of major systems comprises a social marketplace, a social learning management system, and a virtual classroom. The social marketplace is configured to provide a marketplace for both students and teachers to search and select each other through different interactions. The social marketplace further comprises a booking system, a rating system, a search system, a suggestion system and a reverse bidding system. The search system is configured to allow the user to search for classes, teachers, ratings, reviews, or other relevant information. When the user types in the search word, the suggestion system, which is powered by AI, will also provide other relevant information, such as learning path suggestion. For example, if a user wishes to learn about patent law, the AI will check student's profile, and suggest other prerequisite courses, such as “Introduction to Intellectual Property”, if the user does not have any prior knowledge. If the AI determines that the user has taken several relevant courses, then the AI may also suggest other relevant courses to the user. After the user found the desired course, the user may customize or choose the format of learning, which includes but not limits to group learning, private class, or tutor. Then the user may book the course if the user fulfilled the prerequisite. After the course is booked, the user may receive a partial or full refund if he is not satisfied with the class.

The rating system is configured to allow the user to provide ratings, feedbacks, comments, or other types of evaluations to different subject matters. In the present embodiment, the user may provide ratings to the classes offered, to the teachers, or suggest how to improve the system. The system will record ratings or other feedbacks and promote the teacher or the student accordingly. For example, if a teacher receives good rating from students or other teachers, the system may promote the teacher by making both the teacher and relevant courses more visible to other users. The system may create a chart that lists star teachers for all users. In the future embodiments, the user may provide various feedbacks to even more subject matters, including but not limited to peer evaluation, or other contributions to the classes.

The reverse bidding system is configured to expand the number and type of classes offered in the interactive learning system. When the user wishes to learn, but cannot find any relevant class, or when the user wishes to expand an existing class, then the user may use the reverse bidding system. The user can enter relevant subject matters, type of skills, or other relevant information. The reverse bidding system will send notifications to other users with relevant skill set to post a bid. The reverse bidding system will select a number of winners, depends on the number of users posting. After winner is selected, the winner may set up the lesson plan on the teacher's interface and send the information to users to book the class. If no bid is placed by any user in a certain period of time, then the user requesting the class may join or create an interest group to connect with other users to arrange availability with teachers. The user may also submit a request to administration to help recruit teachers.

The social learning management system further comprises a plurality of groups, an event management system, and a delivery system. The social learning management system is configured to facilitate the learning between the all the user. In the present embodiment, the system does not define a registered user as “teacher” or “student”. An engineer may act as a teacher and teach an engineering related courses but may act as a student when taking a legal class. The social learning management system has different interfaces when the user needs to switch between different roles, which includes but not limited to teacher, student, facilitators, or other roles. The plurality of groups comprises multiple social forums to facilitate discussions between users, regardless whether the user is acting as a teacher, student, or other roles. When acting as a teacher, the user may discuss, exchange, learn teaching methods or other information from other teachers. When acting as a student, the user may discuss, evaluate, or assist other students regarding different courses. The teacher may also establish discussion groups to further interact with students.

The event management system is configured to allow the user to create and organize both online and offline events relevant to the courses. For example, in an art class, if the teacher is aware of a special artwork is relocating to a nearby museum, then the teacher may create an offline event to take nearby students to the museum and conduct a lesson near the artwork. Students may also organize study sessions or other interactions online or offline by the event management system. The teacher may exercise a certain level of control or manage different events with a certain level of administrative capacity in the teacher's class.

The delivery system is configured to provide the class material and feedbacks to the user's portable, or other home electronic devices. The teacher may provide lectures or other presented material by pre-recording videos with the delivery system or provide a live-session. The student may also ask questions immediately during the live session or can send messages to class's group, the teacher's email, or other messaging systems via the delivery system. The student may also choose to send messages anonymously. The virtual classroom comprises a video conferencing system, an augmented reality system, and a virtual reality system. Future embodiments may comprise more systems to accommodate different styles of teaching. The video conferencing system is configured to allow the teacher to provide a lecture. In the present embodiment, the teacher may pre-record lecture videos or use the live video conferencing function to interact with students via portable or other electronic devices. Students may provide live or message feedbacks to the teacher regarding the class material during or after viewing the video.

The augmented reality system comprises motion and image tracking function and is configured to accommodate different type of classes. For example, in a guitar lesson, the teacher may pre-record how one song was played by a guitar with the augmented reality system, then the student will use the same system trying to match how the teacher plays. The augmented reality system can also score the student by comparing the similarity of movement and sound between the teacher's model play and the student's practice. The virtual reality system is configured to provide different variety of learning for students. For example, if a user wishes to learn about how to be a tour guide, instead of having a lecture with many PowerPoint slides, the teacher may try to shadow and communicate with an actual tour guide to obtain the first-hand material from different viewpoints to facilitate learning.

In the present embodiment, as the user registered with the interactive learning system, the user may choose to be a student or a teacher. Future embodiments may create different roles for the user to choose from. The following provides a walkthrough of how the student interacts with the learning system in the present embodiment. Future embodiments may add or remove certain steps. After the user registered with the interactive learning system and start searching for courses, the interactive learning system will display the search results by the filter. If a course is found, then the system will display teacher's profile, timetable, introduction, or other relevant information regarding both the course and the teacher for the student to review. If the student books this course, then the Deep Learning AI will check whether the student fulfilled the prerequisite to take this class. If the student fulfilled the prerequisite, then the student may choose the option of private class. If the student chooses a private class and pass the conflict check, then the booking process is completed, and the interactive learning system will automatically add the student to a system created course group. If the student chose a public class, then the student may search and choose to join course group or may create a course group. The interactive learning system will automatically add other students to this course group and complete the course booking process. If the student cannot find any courses, the student may use the abovementioned reverse bidding system. If the student does not qualify to take the class, then the student may try to search again, or book the courses suggested by the Deep Learning AI system.

After the booking is completed, the student may take attend class with the virtual classroom system. The student may contact the administration if a problem exists. If the problem cannot be resolved, then the course may be canceled or rescheduled. The student may receive a partial or full refund. Students may provide feedbacks or ratings throughout the course. All the feedbacks or ratings will be recorded in the interactive learning system database for future reference and promoting both teacher and student. For example, if a teacher receives good feedbacks from students, teachers, or other facilitators, then the system will promote the teacher by making the courses offered by the teacher more visible to users.

The following provides a walkthrough of how the teacher interacts with the learning system in the present embodiment. Future embodiments may add or remove certain steps. After the user registered with the system as a teacher, the teacher needs to read and agree with the interactive learning system's guideline and agree to the terms of service, then complete teacher's profile, which includes but not limits to background information, experience, or expertise of the teacher. The Deep Learning AI may use the teacher's profile to determine whether the teacher is qualified to teach a certain course. The teacher can then create a course by entering relevant information such as timetable, course schedule, or content. After the course passed the copyright check, the interactive learning system will create groups for the course. If the teacher received any inquiry from students with the confirmed booking, then the teacher may start to teach, assign homework, and interact with students with feedbacks or ratings.

Although the invention has been explained in relation to its preferred embodiment, it is to be understood that many other possible modifications and variations can be made without departing from the spirit and scope of the invention as hereinafter claimed.

What is claimed is:

1. A method of selective interaction with online educational programs, the method comprises the steps of:
(A) providing a plurality of user accounts managed by at least one remote server, wherein each user account is associated with a corresponding personal computing (PC) device;
(B) providing a plurality of online classes managed by the remote server, wherein each online class is associated with at least one corresponding student account from the plurality of user accounts, and wherein each online class is associated with at least one corresponding teacher account from the plurality of user accounts;
(C) executing a matching process between the plurality of user accounts and the plurality of online classes with the remote server in order to identify at least one suggested class for at least one specific account, wherein the suggested class is from the plurality of online classes, and wherein the specific account is from the plurality of user accounts;
(D) prompting the specific account to either join or instruct the suggested class with the corresponding PC device, if the suggested class of the specific account is identified in step (C);
(E) appending the specific account into the at least one corresponding student account of the suggested class with the remote server, if the suggested class is selected to be joined by the specific account in step (D);
(F) appending the specific account into the at least one corresponding teacher account of the suggested class with the remote server, if the suggested class is selected to be instructed by the specific account in step (D); and
(G) hosting each online class in a desired format through the remote server, wherein the desired format is selected by the corresponding teacher account.

2. The method of selective interaction with online educational programs, the method as claimed in claim 1 comprises the steps of:
providing each user account with career-description information;
comparing the career-description information of each user account amongst each other with the remote server during step (C) in order to identify at least one career-aligned account to the specific account, wherein the career-aligned account is from the plurality of user accounts;
comparing the career-description information of the specific account to the career-description information of the career-aligned account with remote server in order to identify at least one missing class from the career-description information of the specific account, wherein the missing class is from the plurality of online classes; and
designating the missing class as the suggested class for the specific account with the remote server.

3. The method of selective interaction with online educational programs, the method as claimed in claim 2 comprises the steps of:
providing the career-description information of each user account with a plurality of career-notable entries, wherein the plurality of user accounts includes the specific account and a plurality of remainder accounts;
proportionally assessing a similarity score for each remainder account in accordance to a number of shared entries between the career-notable entries of the specific account and the career-notable entries of each remainder account with the remote server;
comparing the similarity score of each remainder account amongst each other with the remote server in order to identify at least one matching account with a highest similarity score, wherein the matching account is from the plurality of remainder accounts; and
designating the matching account as the career-aligned account with the remote server.

4. The method of selective interaction with online educational programs, the method as claimed in claim 3 comprises the steps of:
providing at least one shared entry between the career-notable entries of the specific account and the career-notable entries of at least one arbitrary account, wherein the arbitrary account is any one of the plurality of remainder accounts, and the shared entry is contextually related to professional experience; and
applying a larger weight for the shared entry onto the similarity score of the arbitrary account with the remote server.

5. The method of selective interaction with online educational programs, the method as claimed in claim 3 comprises the steps of:
providing at least one shared entry between the career-notable entries of the specific account and the career-notable entries of at least one arbitrary account, wherein the arbitrary account is any one of the plurality of remainder accounts, and the shared entry is contextually related to professional certification; and
applying a larger weight for the shared entry onto the similarity score of the arbitrary account with the remote server.

6. The method of selective interaction with online educational programs, the method as claimed in claim 2 comprises the steps of:
prompting the specific account to communicate with the career-aligned account with the corresponding PC device;
prompting the career-aligned account to communicate with the specific account with the corresponding PC device, if the specific account selects to communicate with the career-aligned account; and
establishing a line of communication between the specific account and the career-aligned account through the remote server, if the career-aligned account selects to communicate the specific account.

7. The method of selective interaction with online educational programs, the method as claimed in claim 2 comprises the steps of:
tracking a current location for each user account with the remote server;
prompting the specific account to enter an accessible location radius with the corresponding PC device, wherein the accessible location radius originates from the current location of the specific account;
prompting the specific account to setup at least one tutoring session with the career-aligned account with the corresponding PC device, if the accessible location radius is entered by the specific account, and if the current location of the career-aligned account is located within the accessible location radius of the specific account;
prompting the career-aligned account to confirm the tutoring session with the corresponding PC device, if the tutoring session is setup by the specific account; and
sending a confirmation notice for the tutoring session from the remote server to the corresponding PC device of the specific account and to the corresponding PC device of the career-aligned account.

8. The method of selective interaction with online educational programs, the method as claimed in claim 1 comprises the steps of:
providing each user account with a curriculum vitae and each online class with a set of teaching qualifications;
comparing the set of teaching qualifications of the suggested class to the curriculum vitae of each user account with the remote server during step (C) in order to identify at least one matching account for the suggested class, wherein the matching account is from the plurality of online classes; and
designating the matching account as the specific account for the suggested class with the remote server.

9. The method of selective interaction with online educational programs, the method as claimed in claim 1 comprises the steps of:
providing the desired format of at least one arbitrary class as a real-time communication interface, wherein the arbitrary class is any one of the plurality of online classes;
prompting the corresponding teacher account to enter at least one classroom setting for the arbitrary class with the corresponding PC device;
applying the classroom setting for the arbitrary class to the real-time communication interface with the remote server, if the classroom setting is entered by the corresponding teacher account; and
managing a plurality of educational interactions for the arbitrary class between the corresponding teacher account and the corresponding student account through the real-time communication interface hosted by the remote server.

10. The method of selective interaction with online educational programs, the method as claimed in claim 1 comprises the steps of:
providing the desired format of at least one arbitrary class as a virtual-reality simulation hosted by the remote server, wherein the arbitrary class is any one of the plurality of online classes;
prompting the corresponding teacher account to enter at least one simulation setting for the arbitrary class with the corresponding PC device;
applying the simulation setting for the arbitrary class to the real-time communication interface with the remote server, if the classroom setting is entered by the corresponding teacher account; and
managing a plurality of educational interactions for the arbitrary class between the corresponding teacher account and the corresponding student account through the virtual-reality simulation hosted by the remote server.

11. The method of selective interaction with online educational programs, the method as claimed in claim 1 comprises the steps of:
(H) providing the desired format of at least one arbitrary class as a motion-training simulation hosted by the remote server, wherein the arbitrary class is any one of the plurality of online classes;
(I) prompting the corresponding teacher account to enter an ideal-motion video for the arbitrary class with the corresponding PC device;
(J) displaying the ideal-motion video for the arbitrary class through the corresponding PC device of the corresponding student account, if the ideal-motion video is entered by the corresponding teacher account;
(K) capturing a plurality of body-reference points during an actual-motion video with the corresponding PC device of the corresponding student account;
(L) comparing the actual-motion video to the ideal-motion video with the remote server in order to identify at least one misaligned point from the plurality of body-reference points;
(M) sending a notification for the misaligned point from the remote server to the corresponding PC device of the corresponding student account; and
(N) executing a plurality of iterations for steps (K) through (M), until the corresponding student account confirms completion of the motion-training simulation with the corresponding PC device.

12. The method of selective interaction with online educational programs, the method as claimed in claim 11 comprises the steps of:
prompting the corresponding student account to communicate with the corresponding teacher account with the corresponding PC device after step (M);
prompting the corresponding teacher account to communicate with the corresponding student account with the corresponding PC device, if the corresponding student account selects to communicate with the corresponding teacher account; and
establishing a line of communication between the corresponding student account and the corresponding teacher account through the remote server, if the corresponding teacher account selects to communicate the corresponding student account.

13. The method of selective interaction with online educational programs, the method as claimed in claim 1 comprises the steps of:
(O) prompting each user account to enter a class search request with the corresponding PC device;
(P) relaying the class search request of at least one arbitrary account from the corresponding PC device to the remote server, wherein the arbitrary account is any account from the plurality of user accounts;
(Q) comparing the class search request to each online class with the remote server in order to identify at least one matching class from the plurality of online classes;
(R) prompting the arbitrary account to join the matching class with the corresponding PC device, if the matching class is identified in step (Q);
(S) appending the arbitrary account into the at least one corresponding student account of the matching class with the remote server, if the matching class is selected to be joined by the arbitrary account in step (R); and
(T) compiling the class search request into a missing class note with the remote server, if the matching class is not identified in step (Q).

14. The method of selective interaction with online educational programs, the method as claimed in claim 13 comprises the steps of:
providing a class-necessity threshold stored on the remote server;
managing a count for the missing class note with the remote server;
executing a plurality of iterations for steps (O) through (T), wherein the count for the missing class note is incremented for each occurrence of step (T) during the plurality of iterations for step (O) through (T);
prompting each account to instruct the missing class with the corresponding PC device, if the count for the missing class note is greater than the class-necessity threshold; and
appending the missing class into the plurality of online classes with the remote server, if the missing class is associated with at least one new corresponding teaching account, wherein the new corresponding teaching account is from the plurality of user accounts.
